(19) United States
(12) Patent Application Publication
(10) Pub. No.: US 2025/0086714 A1
(43) Pub. Date: Mar. 13, 2025

(54) SYSTEM AND METHOD FOR SECURITY PROMOTION AND ADVISOR ASSISTED TRADE

(71) Applicant: 1-ClickTrade IP Holdings, Inc., Santa Monica, CA (US)

(72) Inventor: Jerry Cooper, Santa Monica, CA (US)

(21) Appl. No.: 18/828,705

(22) Filed: Sep. 9, 2024

Related U.S. Application Data
(60) Provisional application No. 63/537,325, filed on Sep. 8, 2023.
(60) Provisional application No. 63/561,685, filed on Mar. 5, 2024.
(60) Provisional application No. 63/660,934, filed on Jun. 17, 2024.

(51) Int. Cl. G06Q 40/04; G06F 16/957

(52) U.S. Cl. CPC G06Q 40/04; G06F 16/9574

(57) ABSTRACT

A system for exchange traded fund promotion and trade stores a cached webpage on a client device, the cached webpage being retrieved by an application running on the client device based on a URL. The system determines that the URL is listed in an active page list and generates code for an action button based on a stock symbol listed on the cached webpage. The system inserts the code into the cached webpage at a position defined by the active page list and corresponding to the stock symbol. The action button triggers an assistant running on the client device to redirect the application to a transaction webpage of a brokerage for a security identified by the stock symbol, to automatically log into an account of an advisor with the brokerage, and to navigate to the transaction webpage corresponding to the security.

### RELATED APPLICATIONS

This application claims priority to U.S. Patent Application Ser. No. 63/537,325, filed Sep. 8, 2023, to U.S. Patent Application Ser. No. 63/561,685, filed Mar. 5, 2024, and to U.S. Patent Application Ser. No. 63/660,934, filed Jun. 17, 2024, each of which is incorporated herein by reference in its entirety.

### BACKGROUND

A security sponsor (e.g., a financial company) creates and manages a security (e.g., an exchange traded security, an alternative traded security, etc.). However, certain securities are regulated by the Securities and Exchange Commission (SEC) under the Investment Company Act of 1940. Accordingly, investors (e.g., financial advisors or individual investors) are required to buy (and sell) shares of these securities through a Registered Investment Advisor (RIA) (e.g., a certified broker-dealer) at market-determined prices. The security sponsor may generate a security promotion for their security, but other than simply directing (e.g., using a generic URL) potential investors to generic websites of one or more RIAs (e.g., a major trading platforms that provide trading in multiple securities), the security sponsor cannot provide easy access to trade options specifically for their security. For example, the URLs provided in the security promotion directs the potential investor towards a generic website of a selected RIA, and the potential investor is left to navigate that generic website to find the security and initiate a trade.

### SUMMARY

One aspect of the present embodiments includes the realization that navigating through a generic website of a Registered Investment Advisor (RIA) to find a security of interest and then initiate a trade, opens a potential investor to distraction away from the security of interest. Thus, when directed to the generic website from a promotion of a specific security provided by the security sponsor, the potency of the promotion is lost. The distraction occurs because the RIA offers trade of many securities from many different security sponsors, requiring the potential inventor to remember and select or search for the security of interest. Thus, being directed to the RIA website immediately loses focus on the specific security being promoted by the security sponsor. The present embodiments solve this problem by implementing an enablement platform and providing the security sponsor with a unique one-click URL that directs (when selected from the promotion it is embedded in) the potential investor to an intermediary webpage hosted by the enablement platform. The intermediary webpage maintains focus on the security sponsor and/or a specific security of interest by providing a webpage with direct access to purchase the security through at least one RIA. Advantageously, the intermediate webpage presents only the securities of the security sponsor that are of interest to the potential advisor, thereby not diluting the power of the promotion by the security sponsor. Additionally, the intermediary webpage provides the potential inventor with a more direct path to purchase of the securities of interest since they are already preselected by the enablement platform.

Where the potential inventor is a financial advisor, the enablement platform allows the advisor to register and define at least one client's financial preferences (e.g., financial risk category). The enablement platform uses the client's financial preferences to list only clients having preferences that match a risk category of the displayed securities. Advantageously, the advisor is presented with options to buy the security only for clients matching the security risk category. Accordingly, the enablement platform provides additional assistance and protections to the advisor and the advisor's clients by preventing purchase of the securities for unsuitable clients.

In certain embodiments, the techniques described herein relate to a method, including: storing a cached webpage on a client device, the cached webpage being retrieved by an application running on the client device based on a URL; determining that the URL is listed in an active page list; generating code for an action button based on a symbol listed on the cached webpage; and inserting the code into the cached webpage at a position defined by the active page list and corresponding to the symbol.

In certain embodiments, the techniques described herein relate to a method, including: storing a cached webpage on a client device, the cached webpage being retrieved by an application running on the client device based on a URL; finding a stock symbol in an element of the cached webpage; determining that the stock symbol is listed in a traded symbols list; generating code for an action button based on the stock symbol and an advisor; and inserting the code into the cached webpage, wherein the action button appears near the stock symbol when the cached webpage is displayed on the client device.

In certain embodiments, the techniques described herein relate to a method, including: generating, on an enablement platform, a one-click URL with a security sponsor ID that uniquely identifies a security sponsor, wherein the one-click URL is included in a promotion for a security of the security sponsor; receiving, from an activity monitor running on a client device of an advisor, activity data of the advisor using the client device; updating an advisor register and a client register of the enablement platform based on the activity data; generating assist directives based on the activity data; receiving a webpage access request from a browser in response to selection of the one-click URL; determining the security based on the security sponsor ID received in the webpage access request; determining at least one client ID based on an advisor ID received from the client device; generating a webpage listing the client ID and security information of the security with an action button when a security risk category of the security matches a client risk category of the client ID; and triggering an assistant running on the client device to navigate to a transaction webpage of a brokerage in response to selection of the action button by the advisor.

### BRIEF DESCRIPTION OF THE FIGURES

FIG. 1 is a high-level block diagram illustrating one example system for exchange traded fund promotion and trade, in embodiments.

FIG. 2 shows the system of FIG. 1 in further example detail, in embodiments.

FIGS. 3, 4 and 5 are a flowchart illustrating one example method for security promotion and advisor assisted trade, in embodiments.

FIG. 6 shows the activity data of FIG. 1 in further example detail, in embodiments.

FIG. 7 is a block diagram illustrating one example button generator that inserts a buy button near a stock symbol on a cached webpage viewed on the client device of FIG. 1, in embodiments.

FIG. 8 is a flowchart illustrating one example method for adding the buy button near a stock symbol for a security on a cached webpage viewed on the client device of FIG. 1, in embodiments.

FIG. 9 is a flowchart illustrating one example method for dynamically inserting buy buttons on a cached webpage, in embodiments.

FIG. 10A is a screenshot illustrating one example webpage prior to insertion of a buy button.

FIG. 10B is a screenshot of the webpage of FIG. 10A after insertion of a buy button defined by the active page list of FIG. 7, in embodiments.

FIG. 11A is a screenshot illustrating one example webpage 1100 prior to insertion of buy button 724.

FIG. 11B is a screenshot of the webpage of FIG. 11A after a buy button is dynamically inserted, in embodiments.

FIG. 12 is a screenshot of the webpage of FIG. 11B further illustrating a pop-up menu that is generated in response hovering a mouse pointer over the buy button, in embodiments.

FIG. 13 is a screenshot of a webpage of a brokerage that is automatically opened by the assistant of FIG. 1 in response to the advisor clicking on the buy button, in embodiments.

### DETAILED DESCRIPTION OF THE EMBODIMENTS

Registered Investment Advisor (RIA) manages the assets of high-net-worth individuals and institutional investors. RIAs can create portfolios with individual stocks, bonds, and mutual funds; they may use a mix of funds and individual issues or only funds to streamline asset allocation and cut down on commission costs. RIAs are registered with either the U.S. Securities and Exchange Commission (SEC) or state securities administrators. RIAs and the people who work from them have fiduciary obligations to their clients, meaning that they have a fundamental duty to always and only provide investment advice that is in their client's best interests.

Exchange Traded Fund (ETF) can be used as the building blocks of a portfolio or as a complement to other investments owned, by providing further diversification.

Security refers to any marketable security or financial instrument that may be traded (e.g., on either a secure exchange or an open exchange), and includes one or more of: an ETF, a mutual fund, an alternative mutual fund (ALT), a commodity (e.g., gold, silver, etc.), a cryptocurrency (e.g., Bitcoin), etc.

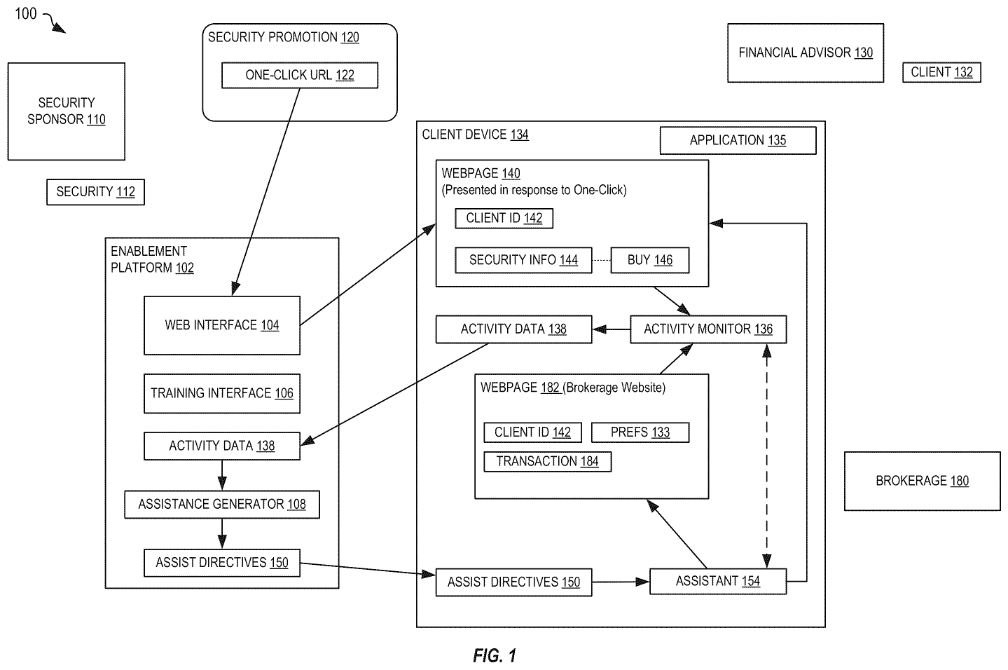

FIG. 1 is a high-level block diagram illustrating one example system 100 for exchange traded fund promotion and trade, in embodiments. A security sponsor 110 creates and/or maintains a security 112 and, to advertise security 112, generates a security promotion 120 that may be viewed by a financial advisor 130 on behalf of a client 132. Advisor 130 may also represent a self-directed investor, without departing from the scope hereof. Security promotion 120 is, for example, an email generated by security sponsor 110 and/or a webpage displayed by, or for, security sponsor 110.

Advisor 130 uses a client device 134 (e.g., one of a smartphone, a tablet computer, a laptop computer, etc.) to interact with at least one webpage 182 of a brokerage 180, on behalf of client 132 for example. For example, client device 134 may run an application 135 that may be a web browser or bespoke software of system 100 that facilitates communication with enablement platform 102. Client 132 may have a preference for using brokerage 180, for example. Client device 134 also runs an activity monitor 136 that captures activity data 138 indicative of interaction by advisor 130 with webpage 182. For example, activity data 138 indicates input to webpage 182 by advisor 130 and output from webpage 182, such as displayed content thereof.

System 100 includes an enablement platform 102 with a web interface 104 that generates a one-click URL 122 that is unique to security 112 and/or security sponsor 110. Enablement platform 102 may be implemented in the cloud (e.g., a cloud based service) and/or by a network connected server (e.g., a computer with a network interface, a processor, and memory storing machine readable instructions that are executed by the processor to implement the functionality of enablement platform 102 as described herein. That is, web interface 104 is implemented at least in part by software. Security sponsor 110 generates security promotion 120 to include one-click URL 122. When advisor 130 selects one-click URL 122 within security promotion 120, web interface 104 receives a webpage access request and generates an intermediary webpage 140 for display to advisor 130.

As described in further detail below, web interface 104 may use information of client 132 to select and display security information 144 within webpage 140. For example, web interface 104 may generate webpage 140 to display a client ID 142 (e.g., an account number and/or a name of client 132) together with security information 144 (e.g., information of security 112) and a corresponding buy button 146 (also referred to as an action button). Particularly, one-click URL 122 uniquely identifies security sponsor 110, whereby web interface 104 selects security 112 for display only when security 112 is suitable for client 132.

Client 132 may prefer a brokerage 180 and therefore advisor 130 interacts with at least one webpage 152 of brokerage 180 on behalf of client 132. For example, advisor 130 may register client 132 with brokerage 180 and use brokerage 180 for purchase and sale of securities on behalf of client 132, where brokerage 180 is an RIA.

Activity data 138 is sent to enablement platform 102 where it is processed by an assistance generator 108 to generate assist directives 150 that are sent in return to client device 134 for use by an assistant 154 that cooperates with activity monitor 136 to provide assistance to advisor 130 with one or both of webpage 140 and webpage 182. Assistant 154 is for example an add-in for application 135. Assistance generator 108 may update assist directives 150 as activity data 138 is received from activity monitor 136, at intervals for example.

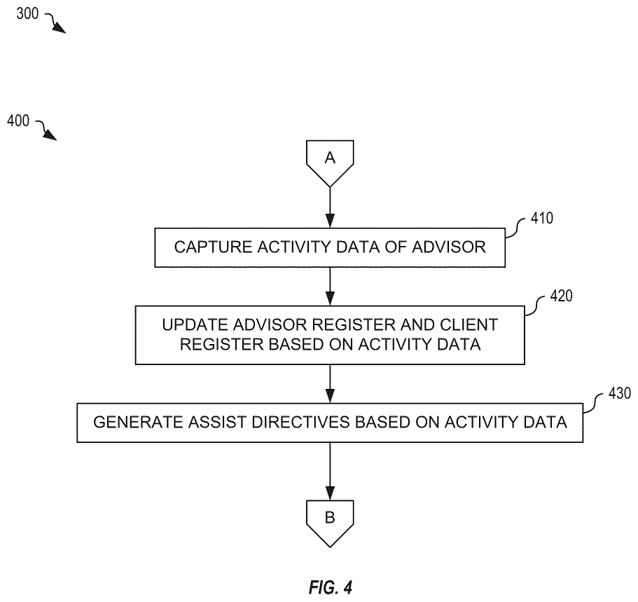

FIG. 6 shows activity data 138 of FIG. 1 in further example detail, in embodiments. Activity data 138 may include one or more of: a ticker symbol 602 that identifies the traded ETFs or model portfolios; a number of shares traded 604, if applicable; a dollar value of trade 606 defining a monetary amount involved in the trade; a date/time of trade 608 defining when the trade was executed; advisor contact information 610 such as name, firm, email, phone, central registration depository (CRD) number, and address; a trade channel 612 categorizing the transaction as Retail (Broker/Dealer or RIA), Institutional, or Self-Directed Investor; a source of click 614 defining an origin of the trade, such as email, webinar, or a specific website; a type of trade portal 616 defining the specific trading platform or portal used for the transaction; a custodian 618 defining the custodial service (e.g., Schwab, Fidelity) involved in the trade; a type of account 620 defining the nature of the account involved (qualified, cash, pension, etc.); an allocation 622 defining information on the trade's allocation within the portfolio; a trend 624 defining market trends or patterns observed at the time of the trade; a date of last trade 626 defining the date of the previous trade made by the same advisor; and an opt-in for marketing 628 indicating whether advisor 130 has opted in for marketing communications. Activity monitor 136 may collect other data without departing from the scope hereof.

As noted above, an RIA is required to trade shares of security 112, and therefore, buy button 146 is configured to invoke webpage 182 of brokerage 180 to buy shares of security 112 on behalf of client 132. Further, selection of buy button 146 triggers assistant 154 to assist advisor 130 by navigating through webpages 182 of brokerage 180 to a corresponding webpage 182 that allows advisor 130 to purchase shares of security 112, providing account information of client 132 as needed by webpage 182, for example. By autonomously navigating through webpages of brokerage 180 to the webpages that correspond to security 112 (based on selection of one-click URL 122 by advisor 130), system 100 ensures that advisor 130 is not distracted from the intended purchase of shares in security 112 for client 132 by other information (e.g., other securities) of brokerage 180.

Advantageously for security sponsor 110, webpage 140 presents only security information 144 of security 112 of security sponsor 110 to advisor 130. Advantageously for advisor 130, webpage 140 provides a more direct path to share purchase of security 112 for client 132 since security 112 is already preselected by enablement platform 102 when one-click URL 122 is selected, and that selection of security 112 is further carried through webpages of brokerage 180. Further, advisor 130 maintains control of the transaction (e.g., transaction 184, FIG. 1) at all time, since assistant 154 waits for confirmation of the purchase by advisor 130.

In certain embodiments, enablement platform 102 implements a training interface 106 that provides at least one webpage (similar to webpage 182) that interacts with advisor 130 to teach advisor 130 how assistant 154 assists with navigation through brokerage websites and further allows activity monitor 136 to capture activity data 138 that shows preferences (e.g., preferences 133) and procedures used by advisor 130.

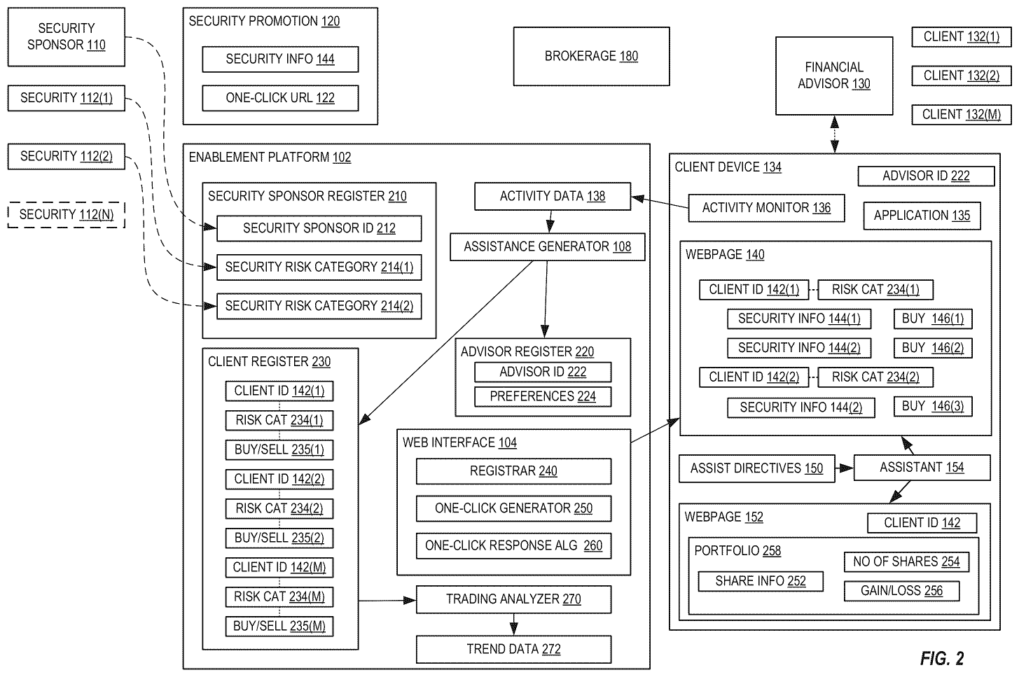

FIG. 2 shows system 100 of FIG. 1 in further example detail, in embodiments. Web interface 104 includes a registrar 240, a one-click generator 250, and a one-click response algorithm 260.

Registrar 240 implements an interactive interface that allows security sponsor 110 to register with enablement platform 102. Enablement platform 102 includes an security sponsor register 210 (e.g., implemented within a database of enablement platform 102) that stores security sponsor ID 212 (e.g., a unique identifier of security sponsor 110) in association with an security risk category 214 for at least one security 112 of security sponsor 110. In the example of FIG. 2, security sponsor 110 manages securities 112(1)-(N). Enablement platform 102 may store security sponsor ID 212 and security risk category 214 of more than one security sponsor 110. One-click generator 250 is invoked to generate one-click URL 122 for security sponsor 110. For example, one-click generator 250 generates one-click URL 122 to reference webpage 140 and include security sponsor ID 212.

Registrar 240 also allows advisor 130 to register with enablement platform 102, which includes an advisor register 220 that stores an advisor ID 222 that uniquely identifies advisor 130 and may also store preferences 224 (described in further detail below) of advisor 130. Once registered with enablement platform 102, advisor 130 installs activity monitor 136 onto client device 134. For example, registrar 240 may invite advisor 130 to install activity monitor 136 on client device 134 when registering with enablement platform 102. Activity monitor 136 monitors interaction of 130 with brokerage 180 to capture activity data 138, which is sent to assistance generator 108 of enablement platform 102. Assistance generator 108 processes activity data 138 and extracts information of clients 132 of advisor 130 and autonomously updates a client register 230 of enablement platform 102. For example, assistance generator 108 may determine a client ID 142, a risk category 234, and buy/sell data 235 for clients 132 as advisor 130 interacts with webpages of brokerages 180. In the example of FIG. 2, advisor 130 has clients 132(1)-(M) and client register 230 is updated by assistance generator 108 to store client IDs 142(1)-(M) and risk categories 134(1)-(M). During registration of advisor 130, registrar 240 may also store advisor ID 222 with client device 134 such that it may be used by activity monitor 136 to identify activity data 138 as belonging to advisor 130. In certain embodiments, activity monitor 136 authenticates advisor 130, using biometric data for example, when collecting activity data 138. Activity data 138 also includes information (e.g., number of shared traded 604, dollar value of trade 606, date/time of trade 608, etc.) of transactions made by advisor 130 for each client 132 and assistance generator 108 may record corresponding buy/sell data 235 within client register 230.

When one-click URL 122 is selected by advisor 130, one-click response algorithm 260 is invoked to generate webpage 140 with information of securities 112 managed by security sponsor 110. For example, one-click response algorithm 260 uses security sponsor ID 212 from one-click URL 122 to select security risk categories 214 associated with security sponsor 110. One-click response algorithm 260 also retrieves advisor ID 222 from application 135 to identify advisor 130 and uses advisor ID 222 to select ones of clients 132 where risk category 234 matches security risk category 214 of securities 112 of security sponsor 110. One-click response algorithm 260 then generates webpage 140 to list, for each client ID 142, security information 144 of each matched security 112 and a corresponding buy button 146. For example, as shown in FIG. 2, one-click response algorithm 260 may group security information 144 of matching securities 112 for each client 132. In the example of FIG. 2, webpage 140 includes buy buttons 146(1)-(3). In certain embodiments, activity monitor 136 detects one-click URL 122 within security promotion 120 when displayed by application 135 to advisor 130 and initiates communication with one-click response algorithm 260. For example, where security promotion 120 is a webpage, activity monitor 136 detects one-click URL 122 on the webpage and sends a message to one-click response algorithm 260 containing security sponsor ID 212 from one-click URL 122. In certain embodiments, security sponsor ID 212 is encoded elsewhere (e.g., within metadata) within security promotion 120 that may be detected by activity monitor 136.

In the prior art, selection of a link within a promotion directs the advisor to a generic webpage of a broker that requires the advisor to search and/or select specific securities from a list of all securities traded by the broker to make a purchase for a specific client. Advantageously, with system 100, advisor 130 is presented with webpage 140 that lists security information 144 with a direct purchase option (provided by corresponding buy buttons 146) for each client 132 of advisor 130 for which the corresponding security is relevant. Being provided with a list of securities that are related to security promotion 120 of security sponsor 110 together with clients to which the security is a match is a significant advantage over the prior art, particularly, for each security 112, webpage 140 lists only client IDs 142 where risk category 234 matches the corresponding security risk category 214, and therefore purchasing mistakes are avoided, since non-matching securities 112 are not listed on webpage 140.

Further, client register 230 may also store preferences of each client 132 whereby each buy button 146 directs client device 134 towards the preferred brokerage 180 to make the purchase of shared in security 112. Accordingly, when advisor 130 selects one of buy buttons 146 from webpage 140, webpage 152 opens for interaction with the preferred brokerage 180 and assistant 154 uses assist directives 150 to autonomously navigate through webpages of brokerage 180 to a webpage that allows purchase of shares in security 112 for client 132. For example, assistant 154 may supply information (e.g., portfolio data 258 including share information 252, number of shares 254, and gain/loss data 256) of client 132 and or security 112 as needed to navigate through webpages of brokerage 180 to reach a buying page for security 112. Assistant 154 allows advisor 130 to maintain control of purchasing decisions by requiring advisor 130 to take the final action to make the purchase. By automatically initiating the purchase, web interface 104 and assistant 154 simplifies actions required of advisor 130, maintains focus on security sponsor 110, thereby increasing value and potency of security promotion 120.

Advantageously, assistance generator 108 and assistant 154 learn to navigate through webpages of brokerage 180 through activity data 138 as advisor 130 navigates the webpages. Based on this learning, assistance generator 108 generates assist directives 150 to cause assistant 154 to perform future webpage navigation, learns of needed information, and may update preferences 224 of advisor 130 and of clients 132. Where client 132 and advisor 130 do not have a preferred brokerage 180, web interface 104 and assistance generator 108 may use a preferred brokerage of security sponsor 110. In certain embodiments, one or more of assistance generator 108, activity monitor 136, and assistant 154 are implemented using artificial intelligence and/or natural language processing algorithm that learn over time. For example, enablement platform 102 may include a database that stored trained models and/or accumulated data sets that define assist directives 150.

Enablement platform 102 may also include a trading analyzer 270 that processes buy/sell data 235 to generate trend data 272 indicative of trading trends across multiple advisors 130 and/or multiple clients 132. Buy/sell data 235 may also be retrieved by advisor 130 for clients 132 of advisor 130 to verify financial statements. Advantageously, activity monitor 136 and assistance generator 108 operate autonomously to collect and process activity data 138 and therefore client register 230 has reduced risk of human error. For example, one or more of security sponsor register 210, advisor register 220, and/or client register 230 may store transaction data, viewing data, and other such information captured within activity data 138 by activity monitor 136 such that enablement platform 102 may determine statistical information of securities 112, advisors 130, and/or clients 132.

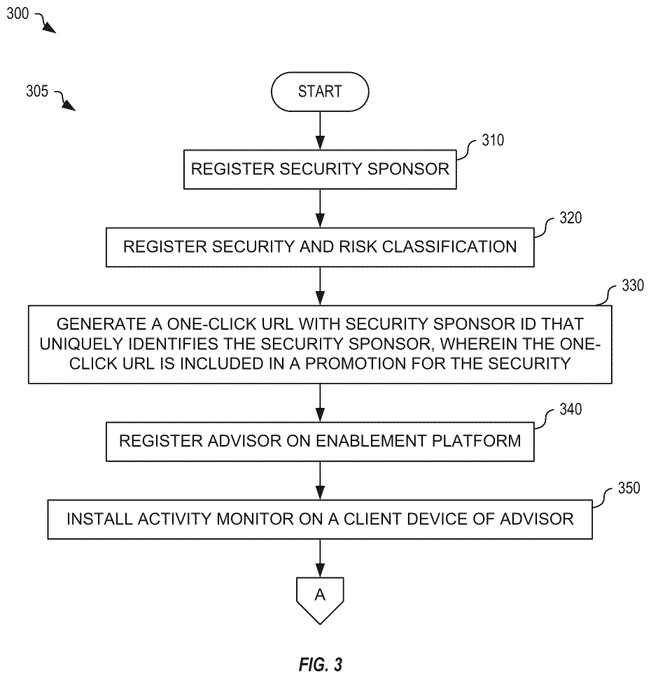

FIGS. 3, 4 and 5 are a flowchart illustrating one example method 300 for security promotion and advisor assisted trade, in embodiments. FIG. 3 is a flowchart illustrating one example registration sub-method 305 implemented by web interface 104 of enablement platform 102 of FIGS. 1 and 2, in embodiments. FIG. 4 is a flowchart illustrating one example data capture sub-method 400 implemented in part by activity monitor 136 on client device 134 of FIG. 2 and in part by assistance generator 108 on enablement platform 102 of FIG. 2, in embodiments. FIG. 5 is a flowchart illustrating one example assist sub-method 500 implemented in part by one-click response algorithm 260 of enablement platform 102 of FIG. 2 and in part by assistant 154 on client device 134 of FIG. 2, in embodiments.

In block 310, registration sub-method 305 registers, on the enablement platform, an security sponsor. In one example of block 310, registrar 240 interacts with security sponsor 110 and generates security sponsor ID 212 that uniquely identifies security sponsor 110.

In block 320, registration sub-method 305 registers, on the enablement platform, a security of the security sponsor and an security risk classification of the security. In one example of block 320, registrar 240 interacts with security sponsor 110 to capture security risk category 214(1) of security 112(1).

In block 330, registration sub-method 305 generates a one-click URL with a security sponsor ID that uniquely identifies the security sponsor, wherein the one-click URL is included in a promotion for the security. In one example of block 330, one-click generator 250 generates one-click URL 122 based on security sponsor ID 212 and sends one-click URL 122 to security sponsor 110 such that it may be included in security promotion 120.

In block 340, registration sub-method 305 registers an advisor on an enablement platform. In one example of block 340, registrar 240 interacts with and identifies advisor 130, generates advisor ID 222 that is unique to advisor 130, and stores advisor ID 222 with application 135.

In block 350, registration sub-method 305 installs an activity monitor on a client device of the advisor. In one example of block 350, registrar 240 interacts with advisor 130 to install activity monitor 136 on client device 134.

Method 300 them proceeds with block 410 of data capture sub-method 400 of FIG. 4.

In block 410, data capture sub-method 400 captures activity data of the advisor. In one example of block 410, activity monitor 136 captures activity data 138 including client ID 142 and risk category 234 of client 132 and activity of advisor 130 that indicates preferences.

In block 420, data capture sub-method 400 updates the advisor register and the client register based on the activity data. In one example of block 420, assistance generator 108 generates at least one assist directives 150 based on activity data 138.

In block 430, data capture sub-method 400 generates assist directives based on the activity data. In one example of block 430, assistance generator 108 generates assist directives 150 based on activity data 138.

Method 300 then continues with block 510 of assist sub-method 500 of FIG. 5.

In block 510, assist sub-method 500 receives, at the enablement platform, a webpage access request from a browser in response to selection of the one-click URL. In one example of block 510, web interface 104 receives a webpage access request from application 135 in response to advisor 130 clicking on one-click URL 122 within security promotion 120.

In block 520, assist sub-method 500 selects the security based on the security sponsor ID received in the webpage access request. In one example of block 520, one-click response algorithm 260 selects security 112 based on security sponsor ID 212 received in the webpage access request.

In block 530, assist sub-method 500 selects the client ID based on the advisor ID. In one example of block 530, one-click response algorithm 260 selects client ID 142 based on advisor ID 222 and associations between advisor register 220 and client register 230.

In block 540, assist sub-method 500 matches the security risk classification to the client risk category. In one example of block 540, one-click response algorithm 260 matches security risk category 214 to risk category 234.

In block 550, assist sub-method 500 generates a webpage listing, when matched, the client ID and security information of the security with a buy button. In one example of block 550, one-click response algorithm 260 generates webpage 140 listing client ID 142(1) and security information 144(1) with buy button 146(1).

In block 560, assist sub-method 500 triggers the assistant to navigate to a share transaction page of a brokerage in response to selection of a buy button. In one example of block 560, assistant 154 uses assist directives 150 to navigate to a share transaction webpage 152 of brokerage 180 in response to 130 selecting buy button 146(2) on webpage 140.

Block 560 may repeat each time one of buy button 146 is selected on webpage 140 by advisor 130.

Blocks 310-560 of method 300 may be performed in a different order and/or may repeat at different intervals without departing from the scope hereof.

### On the Fly Injection of Buy Button on Webpages

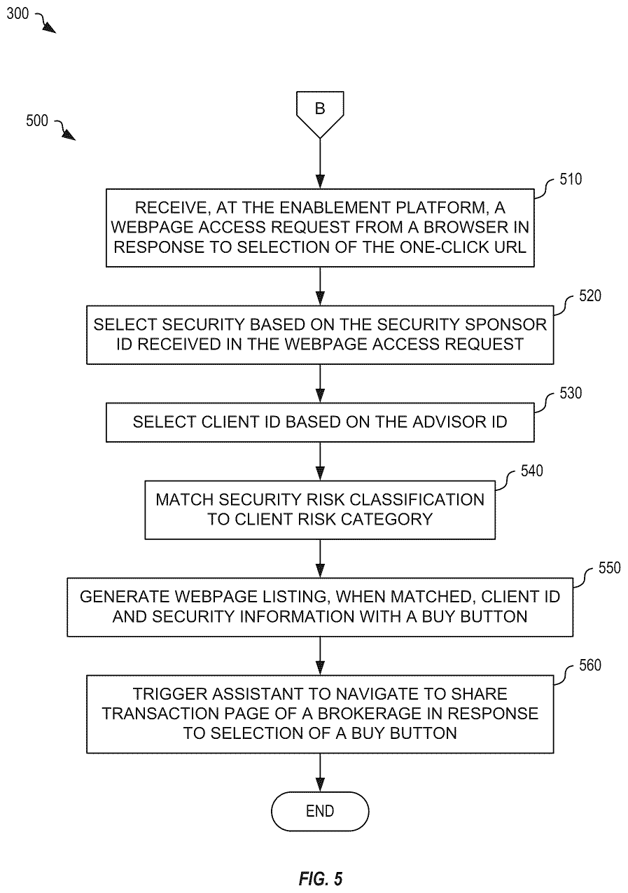

FIG. 7 is a block diagram illustrating one example button generator 722 that inserts a buy button 724 near a stock symbol 746 (e.g., a security reference) on a cached webpage 726 viewed on client device 134 of FIG. 1, in embodiments. Button generator 722 is downloaded and installed onto client device 134 by advisor 130, for example. Button generator 722 is an add-in for application 135 (e.g., a browser), for example. In certain embodiments, button generator 722 and assistant 154 are combined as an add-in to application 135. Enablement platform 102 includes an active page list 704, an ignore page list 706, and a traded symbols list 708. Active page list 704 defines a list of URLs 710 of webpages that have been preprocessed by web crawler 702 for and identified stock symbol 712, whereby active page list 704 may define a position 714 and corresponding code for insertion for buy button 724. Button generator 722 then reads the code for buy button 724 from active page list 704. In certain embodiments, active page list 704 may include a cached webpage corresponding to list of URLs 710 with code already inserted for displaying buy button 724 on that webpage.

Button generator 722 is invoked by application 135 when advisor 130 controls application 135 to access a webpage, and button generator 722 may receive, or otherwise determine, a webpage URL 730 of the webpage (e.g., webpage 744(1) of web site 742(1)) being accessed by application 135. Button generator 722 then searches for webpage URL 730 in active page list 704, received from enablement platform 102, and when not found, sends webpage URL 730 to enablement platform 102. Accordingly, enablement platform 102 tracks webpages being accessed by advisor 130 using client device 134.

Enablement platform 102 includes a web crawler 702 that scans financial websites 742 of vendors 740 to identify webpages 744 that include at least one stock symbol 746 (e.g., a ticker symbol) referencing securities 112 traded through enablement platform 102. Web crawler 702 ignores webpages listed in an ignore page list 706 and adds a URL of any webpage (e.g., webpages 744) that include at least one stock symbol 746 listed in traded symbols list 708 to an active page list 704. Where enablement platform 102 received webpage URL 730 from button generator 722, web crawler 702 may access and evaluate the identified webpage, adding it to active page list 704 when it includes a stock symbol listed in traded symbols list 708. Traded symbols list 708 defines stock symbols of securities 112 traded by enablement platform 102. Ignore page list 706 defines URLs of webpages that are not searched by web crawler 702. That is, web crawler 702 does not access and evaluates webpages having a URL listed in ignore page list 706. Web crawler 702 adds URLs of webpages that include stock symbols listed in traded symbols list 708 to active page list 704.

Web crawler 702 scans webpages 744 of vendors 740 at intervals (e.g., each evening, once a week, etc.), and updated active page list 704 accordingly. In certain embodiments, web crawler 702 may also store metadata for each stock symbol 746 found in active page list 704, where the metadata define characteristics of the stock symbol 746 on the webpage, such as location, format, etc.

Where button generator 722 does not find webpage URL 730 in active page list 704, button generator 722 sends webpage URL 730 to enablement platform 102 to prompt web crawler 702 to scan that webpage for stock symbols listed in traded symbols list 708. When web crawler 702 finds that the webpage includes at least one stock symbol listed in 708, web crawler 702 adds webpage URL 730 to active page list 704.

Application 135 downloads webpage 744(1) into local memory of client device 134, shown as cached webpage 726, and invokes button generator 722 to add buy buttons 724 near stock symbols 746 matched to traded symbols list 708 to cached webpage 726. Advantageously, buy buttons 724 facilitate purchase of securities 112 corresponding to the matched stock symbol through enablement platform 102 as described above. For example, button generator 722 generates a corresponding buy button 724 for each stock symbol 746 found on cached webpage 726 that is also found in traded symbols list 708, inserting buy button 724 on cached webpage 726 near stock symbol 746. Particularly, button generator 722 adds buy button 724 to cached webpage 726 without damaging integrity of the layout of cached webpage 726. For example, button generator 722 may use metadata generated by web crawler 702 and included in active page list 704 for each stock symbol 746 on cached webpage 726.

In certain embodiments, where button generator 722 determines that webpage URL 730 is not found in active page list 704, button generator 722 sends webpage URL 730 to enablement platform 102 and requests an updated active page list 704. Web crawler 702 may then access and search the webpage identified by webpage URL 730, adding webpage URL 730 and corresponding metadata to active page list 704 when the website includes at least one stock symbol also listed in traded symbols list 708. Web crawler 702 may then send the updated active page list 704 to client device 134.

On receiving active page list 704 from enablement platform 102 and determining that webpage URL 730 has been added, button generator 722 updates cached webpage 726 while it is being displayed on client device 134.

### Example Buy Button Code Insertion

A document object model (DOM) is a data representation of objects that comprise the structure and content of a webpage. Cascading style sheets (CSS) is a language used to style an HTML document by defining how HTML elements should be displayed on the webpage. The following code example represents a portion of the DOM for cached webpage 726 prior to button generator 722 inserting buy button 724.

```
<div data-v-5f7cbef2 class=”chart-container” symbol=”VOO”>
  <div class=”flex justify-between”> </div>
  <div data-v-6fb227ea>
    <div data-v-6fb227ea style=”width: 99.9%; height:300px;”> </div>
    <div data-v-6fb227ea class=”flex justify-between mt-8px”>
      <div data-v-6fb227ea class=”flex justify-center items-center text-
black gap-16px”>
        <span class=”text-sm p-8px pl-0px”> ==$0
          <svg viewBox=”0 0 367 232” class-“inline w-16px mr-4px”> </svg>
          “ VOO “
        </span>
      </div>
      <!---->
    </div>
  </div>
</div>
```

The following code example represents the same portion of the code of cached webpage 726 after button generator 722 has inserted code to display buy button 724 on cached webpage 726. The added portion is shown in bold for clarity.

```
<div data-v-5f7cbef2 class=”chart-container” symbol=”VOO”>
  <div class=”flex justify-between”> </div>
  <div data-v-6fb227ea>
    <div data-v-6fb227ea style=”width: 99.9%; height: 300px;”> </div>
    <div data-v-6fb227ea class=”flex justify-between mt-8px”>
      <div data-v-6fb227ea class=”flex justify-center items-center text-
black gap-16px”>
        <span class=”text-sm p-8px pl-0px”> ==$0
          <svg viewBox=”0 0 367 232” class-“inline w-16px mr-4px”> </svg>
          “ VOO “
        </span>
      </div>
      <!---->
    </div>
    <a data-type=”1-clicktrade” data-ticker=”VOO”
href=http://localhost:3000/button?ticker-VOO&quantity=1&sponsor=”
target=” blank” style=”cursor: pointer;” data-uw-rm-ext-link=”na”>
      <img src=”data:image/png;base64, iVBOR...%2FLE4kVUV2y5AAAAAElFTkSuQmCC”
style=”height: 50px;”>
    </a>
  </div>
</div>
```

When advisor 130 selects buy button 724 on cached webpage 726, one or both of web interface 104 and assistant 154 may be invoked to facilitate trading of security 112 identified by stock symbol 746. For example, assistance generator 108 may use activity data 138 captured by activity monitor 136 to determine clients 132 relevant to security 112 identified by stock symbol 746. In certain embodiments, assistance generator 108 may generate webpage 140 and/or webpage 152 to provide advisor 130 with relevant information for making a purchase of at least one security 112. For example, assistance generator 108 may use security sponsor register 210, advisor register 220, client register 230, and/or trend data 272 and present information therefrom to advisor 130 prior to receiving a purchase request.

### Dynamic Button Insertion Pseudocode

The following pseudo code illustrates how buy button 724 is dynamically inserted into cached webpage 726.
Find all elements with the text (trimmed of any starting and trailing whitespaces) that matches a ticker
For each element that matches:
   1. Check to see if a button has already been created
   2. If yes, skip to next element
      else create a button and continue to step 3
   3. If block element (div, p, h1, h2) attach the button inside of the matching element and done
      else if inline elements (span, a, b, strong) attach the button after the matching element and continue to step 4
   4. Link the created button and matching element together
   5. Change position styling on button and compute position of the matching element to place button to the right of the element
   6. On page scroll, on window resize, on elements added or on removed: the computation is run again and the button is moved back into the correct position if the matching element was shifted on the page.

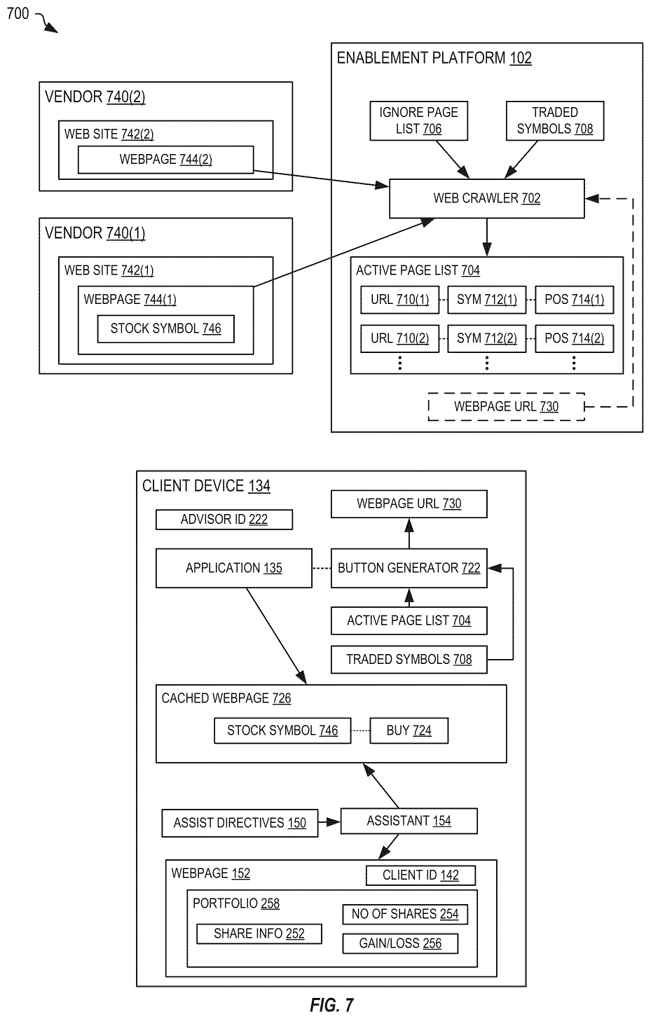

This pseudo code is also represented by method 900 of FIG. 9. Using the example portion of DOM for cached webpage 726, the element (“div data-v-6fb227ea”) on line three is matched as containing stock symbol “VOO”, and since it is a block (e.g., “div”), the code for the generated buy button 724 is inserted within that element (e.g., at the end of the block as shown), and elements on lines five, six, and seven are skipped since the button has already been created.

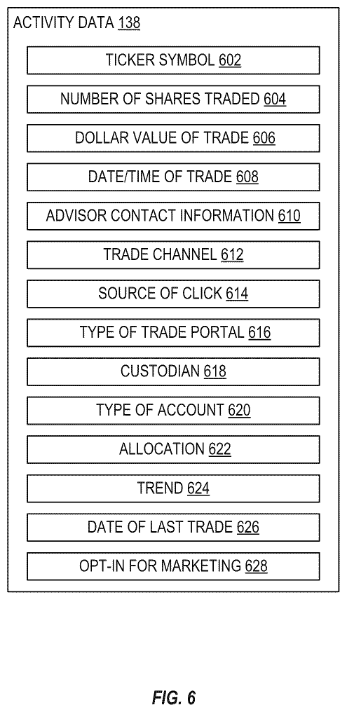

FIG. 8 is a flowchart illustrating one example method 800 for adding buy button 724 near stock symbol 746 for security 112 on cached webpage 726 viewed on client device 134 of FIG. 1, in embodiments. Method 800 is implemented by application 135 and/or button generator 722 of FIG. 7 for example and is invoked when advisor 130 controls application 135 to view webpage 744 containing stock symbol 746 for example.

In block 802, method 800 downloads the webpage to a local cache (e.g., memory of client device 134). In one example of block 804, application 135 downloads webpage 744(1) to local memory of client device 134. In block 804, method 800 compares the URL of the webpage to the active page list. In one example of block 804, button generator 722 compares the URL of webpage 744(1) to entries in active page list 704. Block 806 is a decision. If, in block 806, method 800 determines that the URL does not match an entry in the active page list, method 800 continues with block 808; otherwise, method 800 continues with block 810.

In block 808, method 800 sends the URL of the webpage to the enablement platform. In one example of block 808, button generator 722 sends webpage URL 730 to enablement platform 102. Method 800 then continues with block 816.

Block 810 is a decision. If, in block 810, method 800 determines that at least one position for the buy button is defined within the active page list, method 800 continues with block 812; otherwise, method 800 continues with block 816.

In block 812, method 800 generates buy button(s). In one example of block 812, button generator 722 generates buy button 724 based on stock symbol 746 to include a URL for displaying webpage 152 of brokerage 180 on behalf of client 132. In block 814, method 800 inserts buy button(s) at defined position(s) on the cached webpage. In one example of block 814, button generator 722 inserts code for buy button 724 into cached webpage 726 as defined by position 712(1) of active page list 704. Method 700 then continues with block 818.

In block 816, method 800 dynamically inserts buy button(s) on the cached webpage (e.g., see method 900 of FIG. 9). In one example of block 816, button generator 722 performs method 900 to automatically insert buy button 724 near found stock symbols on cached webpage 726. Method 800 then terminates.

In block 818, method 800 outputs the cached webpage to display. In one example of block 818, application 135 displays cached webpage 726, as modified to include buy button 724, on a display of client device 134.

FIG. 9 is a flowchart illustrating one example method 900 for dynamically inserting buy buttons on a cached webpage. Method 900 is invoked from block 816 of method 800 of FIG. 8.

In block 902, method 900 finds all elements of the cached web page that include a stock symbol. In one example of block 816, button generator 722 searches cached webpage 726 for text matching any stock symbol defined in traded symbols list 708.

Block 904 is a loop that iterates of the found stock symbols of block 902.

Block 906 is a decision. If, in block 906. method 900 determines that a buy button for that stock symbol has already been generates, method 900 continues with block 922; otherwise method 900 continues with block 908. In block 908, method 900 generates buy button code. In one example of block 908, button generator 722 generates URLs and webpage code for buy button 724 corresponding to the current stock symbol.

Block 910 is a decision. If, in block 910, method 900 determines that the element corresponding to the current stock symbol is a block element, method 900 continues with block 912; otherwise method 900 continues with block 914. For example, of the element is one of “div:, “p”, “h1”, or “h2,” then the element is identified as an block element, whereas if the element is one of “span”, “a”, “b” or “strong,” then the element is an inline element.

In block 912, method 900 inserts the buy button inside the block element. In one example of block 912, button generator 722 inserts the code for buy button 724 at the end of the element block as shown in the example buy button code insertion above. Method 900 then continues with block 922.

In block 914, method 900 inserts the buy button code after the matched element. For example, the code for button generator 722 is inserted after the current inline element. In block 916, method 900 links the created buy button and matched element together. In one example of block 916, button generator 722 links buy button 724 and the current element together. In block 918, method 900 computes a position of the matching element and defines a position and styling of the buy button to place the buy button to the right of the element. In one example of block 918, button generator 722 computes a position of the current element on cached webpage 726 as displayed and then defines a position and styling of buy button 724 to place it to the right of the current element on cached webpage 726 as displayed.

In block 920, method 900 recomputes a position of the matching element and redefines the position of button in response to page scroll, on window resize, and on elements added or removed. For example, button generator 722 includes javascript and CSS within the code inserted into cached webpage 726 to recompute the position of buy button 724 such that button generator 722 is repositioned to be to the right of the matching element when the matching element is shifted on cached webpage 726 (e.g., by scrolling, changing the window size, etc.).

Block 922 is an end of the loop, whereby method 900 selects a next stock symbol and matched element and blocks 906 through 920 repeat. Method 900 terminates when all found stock symbols have been processed, such as when buy button 724 is provided for each different stock symbol of cached webpage 726. However, functionality provided by block 920 may still be invoked to reposition each buy button 724 as needed.

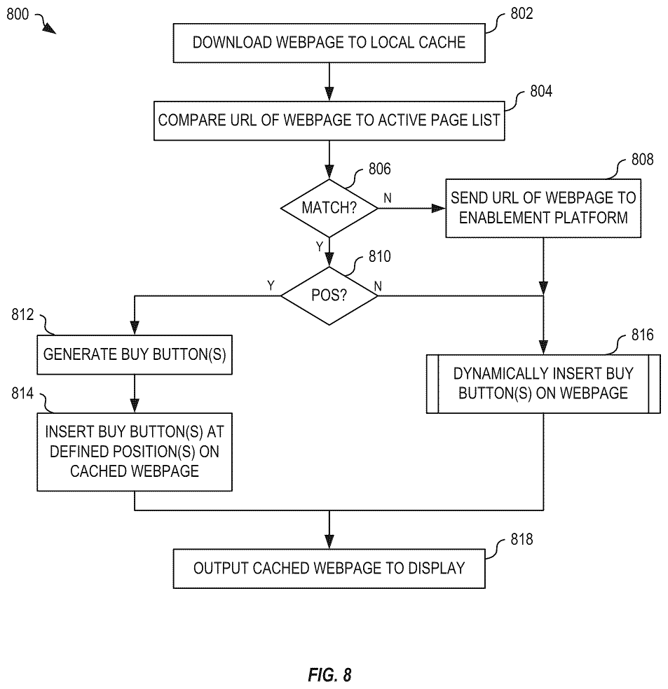

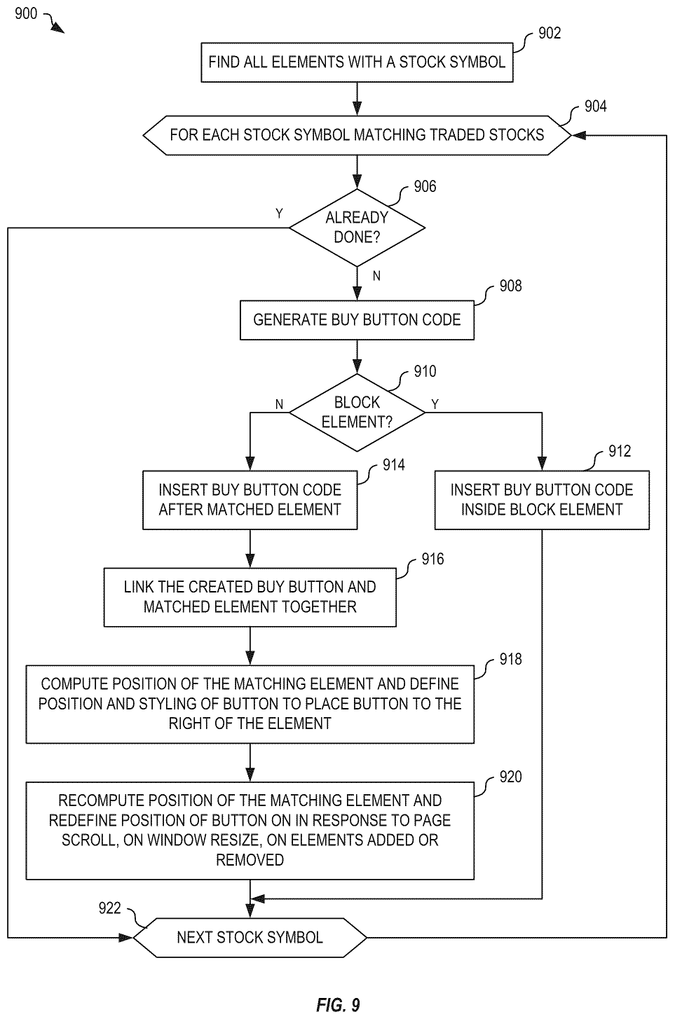

FIG. 10A is a screenshot illustrating one example webpage 1000 prior to insertion of buy button 724. FIG. 10B is a screenshot of a webpage 1050 that represents webpage 1000 of FIG. 10A after insertion of buy button 724 as defined by active page list 704, in embodiments. In this example, webpage 1000 was found by web crawler 702, and active page list 704 was updated to include one or more of list of URLs 710, stock symbol 712, and position 714 such that buy button 724 is easily inserted into cached webpage 726 based on active page list 704.

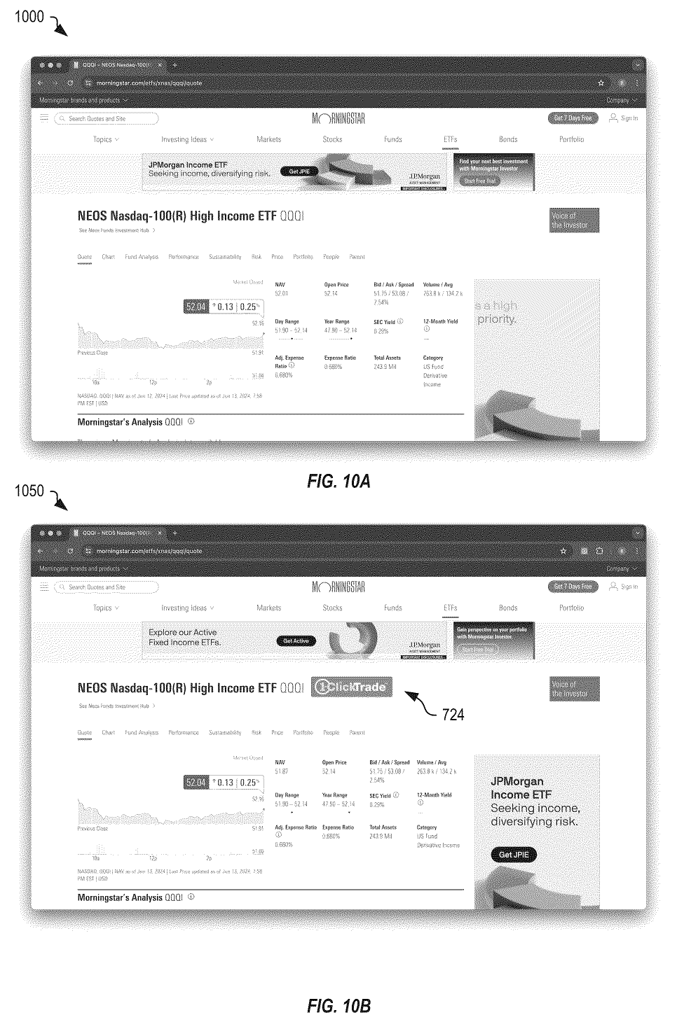

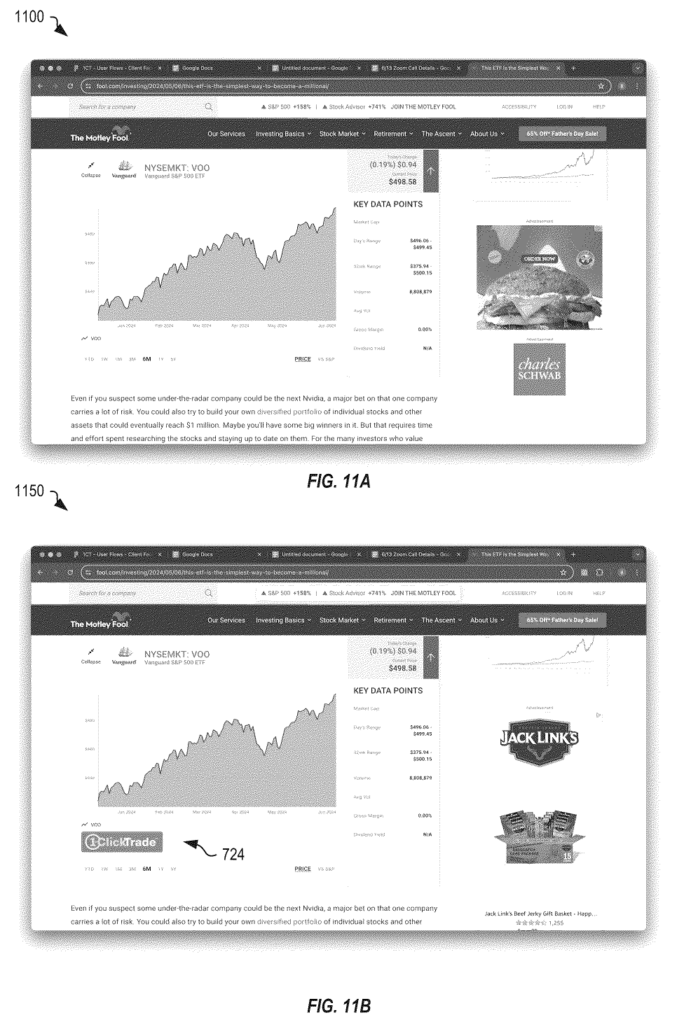

FIG. 11A is a screenshot illustrating one example webpage 1100 prior to insertion of buy button 724. FIG. 11B is a screenshot of webpage 1150 that represents webpage 1100 of FIG. 11A after buy button 724 is dynamically inserted (e.g., on-the-fly) by button generator 722 in response to finding stock symbol “VOO”, in embodiments. For example, as advisor 130 controls application 135 to view webpage 1100, button generator 722 identifies stock symbol “VOO” on webpage 1100 and dynamically inserts buy button 724 into cached webpage 726 such that is displays as shown on webpage 1150. Advantageously, advisor 130 is presented with an easy way trade the corresponding stocks through use of buy button 724.

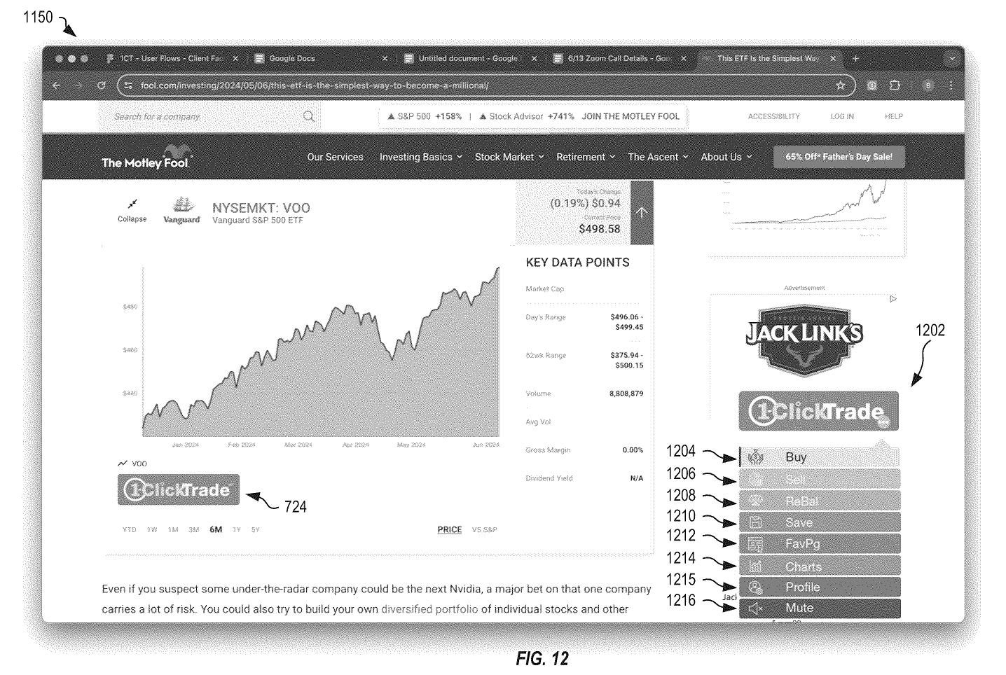

FIG. 12 is a screenshot of webpage 1150 of FIG. 11B further illustrating a pop-up menu 1202 that is generated in response to advisor 130 hovering a mouse pointer over buy button 724, in embodiments. Pop-up menu 1202 is not part of webpage 1100 of FIG. 11A, but is added with buy button 724. For example, when advisor 130 positions the mouse pointer over buy button 724, but does not click, after a short period (e.g., a few seconds), pop-up menu 1202 automatically appears to provide advisor 130 with additional assistance. Pop-up menu 1202 may appear at a fixed position, such as a lower right corner of cached webpage 726, or may appear near buy button 724. Advantageously, pop-up menu 1202 provides access to tools and functionality that would not normally be available on webpage 744, providing advisor 130 with an improved service.

In this example, pop-up menu 1202 includes a direct buy button 1204, a direct sell button 1206, a rebalance button 1208, a save button 1210, a favorite page button 1212, a charts button 1214, a profile button 1215, and a mute button 1216. Pop-up menu 1202 displays at least two actions (e.g., buttons that link to actions) from this list of actions. In certain embodiments, pop-up menu 1202 may also display statistical information on the stock symbol, webpage 1150, and advisor 130, such as a page view number that indicates a number of times advisor 130 has viewed this information over a most recent period (e.g., the last thirty days), and a number of days following that indicates how long advisor 130 has been following this security 112.

In certain embodiments, direct buy button 1204 and direct sell button 1206 may operate similarly to buy button 724 to trigger one or both of assistance generator 108 and assistant 154 to present webpage 152 to further assist advisor 130, as described in detail above with reference to FIGS. 1 and 2, to make a trade in security 112 corresponding to the stock symbol being displayed. For example, selectin any one of buy button 724, direct buy button 1204 and direct sell button 1206 causes assistant 154 to automatically log into an account of advisor 130 with brokerage 180, and then navigate through webpages of brokerage 180 to present advisor 130 with a webpage that allows advisor 130 to make a trade for security 112 corresponding to the stock symbol near buy button 724. Particularly, when advisor 130 clicks on direct buy button 1204, assistant 154 preconfigures the brokerage trade screen (e.g., webpage 152) for a buy operation; when advisor 130 clicks on sell button 1206, assistant 154 preconfigures the brokerage trade screen for a sell operation.

Clicking on rebalance button 1208 by advisor 130 allows the advisor to adjust the allocation of assets in the portfolio of client 132. For example, the advisor wishes to rebalance the client's portfolio to maintain a desired asset allocation. This may involve buying and selling securities to achieve the target balance.

Advisor 130 may click on save button 1210 to save the current settings or preferences. For example, advisor 130 saves the underlying security to a list displayable on enablement platform 102 such that the security is preserved for future reference and/or transactions. Advisor 130 may click on favorite page button 1212 to marks the current webpage as a favorite. For example, advisor 130 marks the current page as a favorite for easy access in the future. This helps in quickly navigating to frequently visited pages based on the viewing algorithm. These lists may be reviewed at any time by advisor 130 through enablement platform 102 such that advisor 130 is remined of any potential trade previously viewed.

Advisor 130 may click on charts button 1214 to displays relevant financial charts. For example, advisor 130 may wish to view a chart from an external service provider, which may be identified on a profile page of advisor 130. The external service provider may provide visual insights into market trends, performance, and other relevant data.

Advisor 130 may click on profile button 1215 to access a profile webpage of advisor 130. For example, advisor 130 may select profile button 1215 to access and edit profile information, that may include one or more of account details, settings, and other relevant information about advisor 130. Clicking on mute button 1216 mutes notifications or sounds generated via enablement platform 102 and/or assistant 154. For example, advisor 130 may click on mute button 1216 to mute notifications or further appearance of the current security on other screens generated by enablement platform 102 and/or assistant 154.

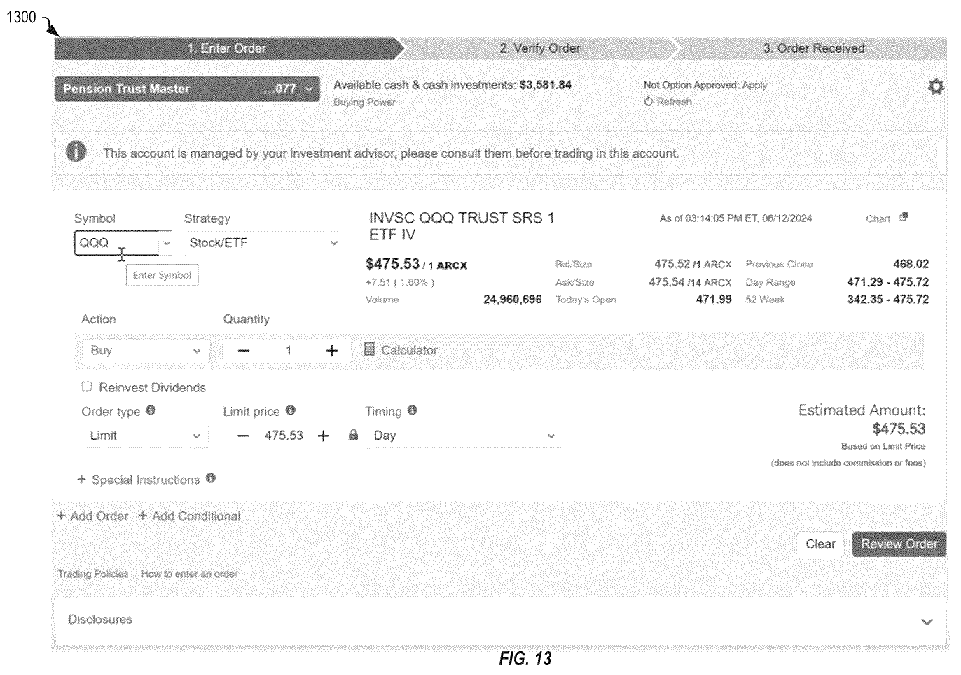

FIG. 13 is a screenshot of a webpage 1300 of brokerage 180 that is automatically opened by assistant 154 in response to advisor 130 clicking on buy button 724 (or either of buy button 1204 and sell button 1206), in embodiments. In this example, assistant 154 automatically logs in to an account of advisor 130 corresponding to client 132 with brokerage 180 and navigates through webpages of brokerage 180 to display webpage 1300 with information of security 112 (e.g., “QQQ” in this example) corresponding to the selected buy button 724. That is, advisor is redirected from an information webpage (e.g., one of webpages 1050 and 1150) to transactional webpage 1300 within a few seconds and without any need to navigate to other platforms or through other webpages.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method, comprising:
storing a cached webpage on a client device, the cached webpage being retrieved by an application running on the client device based on a URL;
determining that the URL is listed in an active page list;
generating code for an action button based on a symbol listed on the cached webpage; and
inserting the code into the cached webpage at a position defined by the active page list and corresponding to the symbol.

2. The method of claim 1, wherein a webpage identified by the URL is preprocessed by a web crawler to identify the symbol and the position.

3. The method of claim 2, the active page list further defining a style for the action button based on content of the cached webpage.

4. The method of claim 1, the generating code comprising reading the code from the active page list based on the URL.

5. The method of claim 1, the action button triggering an assistant running on the client device to redirect the application to a transaction webpage of a brokerage for a security identified by the symbol, the symbol being a stock symbol; wherein the assistant automatically logs into an account of an advisor with the brokerage and navigates to the transaction webpage corresponding to the security.

6. The method of claim 1, further comprising:
generating the code to display a pop-up menu when a mouse pointer is hovered over the action button;
wherein the pop-up menu includes at least two actions from a list of actions consisting of: a direct buy button, a direct sell button, a rebalance button, a save button, a favorite page button, a charts button, a profile button, and a mute button.

7. The method of claim 6, the direct buy button triggering an assistant running on the client device to redirect the application to a transaction webpage of a brokerage for a security identified by the symbol, wherein the assistant automatically logs into an account of an advisor with the brokerage, navigates to the transaction webpage corresponding to the security, and preconfigures the transaction webpage for purchase of the security.

8. The method of claim 6, the direct sell button triggering an assistant running on the client device to redirect the application to a transaction webpage of a brokerage for a security identified by the symbol, the symbol being a stock symbol; wherein the assistant automatically logs into an account of an advisor with the brokerage, navigates to the transaction webpage corresponding to the security, and preconfigures the transaction webpage for sale of the security.

9. The method of claim 6, the rebalance button allowing an advisor to rebalance a portfolio of a client of the advisor.

10. The method of claim 6, the save button saving configuration changes to an enablement platform.

11. The method of claim 6, the favorite page button causing an assistant running on the client device to save the URL to a profile of an advisor.

12. The method of claim 6, the profile button redirecting the application to a profile webpage of an advisor on an enablement platform.

13. A method, comprising:
storing a cached webpage on a client device, the cached webpage being retrieved by an application running on the client device based on a URL;
finding a stock symbol in an element of the cached webpage;
determining that the stock symbol is listed in a traded symbols list;
generating code for an action button based on the stock symbol and an advisor; and
inserting the code into the cached webpage, wherein the action button appears near the stock symbol when the cached webpage is displayed on the client device.

14. The method of claim 13, further comprising:
determining that the URL is not listed in an active page list; and
sending the URL to an enablement platform to cause a web browser to preprocess a webpage identified by the URL.

15. The method of claim 13, further comprising:
determining that the element is a block element; and
inserting the code inside the block element.

16. The method of claim 13, the inserting further comprising:
determining that the element is not a block element;
inserting the code after the element;
linking the action button with the element;
computing a first position of the element; and
defining a second position and a styling of the action button to place the action button to the right of the element when displayed on a display screen.

17. The method of claim 16, wherein a portion of the code is triggered to recompute the first position of the element and redefine the second position of the action button in response to any of a page scroll, a window resize, any element added, and any element removed.

18. The method of claim 13, the action button triggering an assistant running on the client device to redirect the application to a transaction webpage of a brokerage for a security identified by the stock symbol, wherein the assistant automatically logs into an account of the advisor with the brokerage and navigates to the transaction webpage corresponding to the security.

19. The method of claim 13, further comprising:
generating the code to display a pop-up menu when a mouse pointer is hovered over the action button;
wherein the pop-up menu includes at least two actions from a list of actions consisting of: a direct buy button, a direct sell button, a rebalance button, a save button, a favorite page button, a charts button, a profile button, and a mute button.

20. The method of claim 19, the direct buy button triggering an assistant running on the client device to redirect the application to a transaction webpage of a brokerage for a security identified by the stock symbol, wherein the assistant automatically logs into an account of the advisor with the brokerage, navigates to the transaction webpage corresponding to the security, and preconfigures the transaction webpage for purchase of the security.

21. The method of claim 19, the direct sell button triggering an assistant running on the client device to redirect the application to a transaction webpage of a brokerage for a security identified by the stock symbol, wherein the assistant automatically logs into an account of the advisor with the brokerage, navigates to the transaction webpage corresponding to the security, and preconfigures the transaction webpage for sale of the security.

22. The method of claim 19, the rebalance button allowing the advisor to rebalance a portfolio of a client of the advisor.

23. The method of claim 19, the save button allowing the advisor to save configuration changes to an enablement platform.

24. The method of claim 19, the favorite page button causing an assistant running on the client device to save the URL to a profile of the advisor on an enablement platform.

25. The method of claim 19, the profile button redirecting the application to a profile webpage of the advisor on an enablement platform.

26. A method, comprising:
generating, on an enablement platform, a one-click URL with a security sponsor ID that uniquely identifies a security sponsor, wherein the one-click URL is included in a promotion for a security of the security sponsor;
receiving, from an activity monitor running on a client device of an advisor, activity data of the advisor using the client device;
updating an advisor register and a client register of the enablement platform based on the activity data;
generating assist directives based on the activity data;
receiving a webpage access request from a browser in response to selection of the one-click URL;
determining the security based on the security sponsor ID received in the webpage access request;
determining at least one client ID based on an advisor ID received from the client device;
generating a webpage listing the client ID and security information of the security with an action button when a security risk category of the security matches a client risk category of the client ID; and
triggering an assistant running on the client device to navigate to a transaction webpage of a brokerage in response to selection of the action button by the advisor.

27. The method of claim 26, wherein the assistant automatically logs into an account of the advisor with the brokerage and navigates to the transaction webpage corresponding to the security.

28. The method of claim 26, further comprising:
determining buy/sell data for a client of the advisor from the activity data; and
determining trading trend data based on the buy/sell data.

29. The method of claim 26, wherein the activity monitor the advisor interacting the client device to capture the activity data, the activity data including one or more of: a ticker symbol that identifies a traded ETFs or model portfolios; a number of shares traded; a monetary amount involved in a trade; a date/time of the trade; advisor contact information and central registration depository (CRD) number; a trade channel; a source of click defining an origin of the trade; a type of trade portal; a custodian involved in the trade; a type of account; an allocation of the trade within a portfolio of a client; a date of a previous trade made by the advisor; and an opt-in for marketing.
